(19) United States
(12) Patent Application Publication
(10) Pub. No.: US 2015/0338804 A1
(43) Pub. Date: Nov. 26, 2015

(54) IMAGE HEATING APPARATUS

(71) Applicant: CANON KABUSHIKI KAISHA, Tokyo (JP)

(72) Inventors: Yusuke Nakashima, Yokohama-shi (JP); Atsuhiko Yamaguchi, Suntou-gun (JP)

(21) Appl. No.: 14/716,147

(22) Filed: May 19, 2015

(30) Foreign Application Priority Data
May 20, 2014 (JP) 2014-104284
Mar. 25, 2015 (JP) 2015-062476

(51) Int. Cl. G03G 15/20; H05B 3/00

(52) U.S. Cl. CPC G03G 15/2053; H05B 3/0095

(57) ABSTRACT

An image heating apparatus includes a heater including a substrate and a heat generating element provided on the substrate; a supporting member supporting the heater, the supporting member being provided with a recess for receiving the heater; a high heat conduction member having a thermal conductivity at least in a direction parallel with a surface higher than a thermal conductivity of the substrate, the high heat conduction member being sandwiched between the heater and the supporting member. A side surface of the heater and a surface, defining the recess and opposing the side surface of the heater, of the supporting member are bonded by adhesive material with each other to fix the heater and the supporting member to each other.

### FIELD OF THE INVENTION AND RELATED ART

The present invention relates to an image heating apparatus for an image forming apparatus such as an electrophotographic copying machine or an electrophotographic printer.

In an image forming apparatus such as a copying machine or a printer using an electrophotographic type process, a heating type image heating apparatus for fixing an unfixed toner image into a fixed image by heating a recording material (recording paper) carrying a formed unfixed toner image is widely used.

In such an image forming apparatus using the image heating apparatus, when recording sheets having a width smaller than that of an usable maximum width sheet are continuously processed to effect printing, a so-called non-sheet-passage-part temperature rise occurs in the image heating apparatus. By the non-sheet-passage-part temperature rise, a temperature of a region of a fixing nip of the image heating apparatus, with respect to the longitudinal direction, where the recording paper does not pass gradually rises. The durability against a thermal stress stemming from the increase of the electric power supplied to the heating element to meet the recent demand for the high printing speed is desired.

One method for meeting the desire is disclosed in Japanese Laid-open Patent Application 2003-317898, in which a high heat conduction member having a high thermal conductivity in a surface direction as compared with that of a substrate of the heating element is nipped between the heating element and a supporting member for the heating element. It is intended to reduce the temperature rise of the non-sheet-passage-part by the high heat conduction member.

In the case that the heating element (heater) is supported by the supporting member, may be required that the heating element and the supporting member are bonded with each other by an adhesive material, as well as inserting the heating element in a recess of the supporting member.

However, in the case that the high heat conduction member is placed between the heating element and the supporting member in the structure where the heating element and the supporting member are formed and with each other by an adhesive material, a problem arises. That is, a hole is formed in the high heat conduction member, and an adhesive material for bonding the heating element to the supporting member, a uniform heating property of the high heat conduction member is deteriorated, corresponding to the hole formed in the high heat conduction member.

### SUMMARY OF THE INVENTION

Accordingly, it is an object of the present invention to provide an image heating apparatus in which the high heat conduction member is provided between the heating element (heater) and the supporting member, and the heating element and the supporting member are bonded with each other.

According to an aspect of the present invention, there is provided an image heating apparatus comprising a heater including a substrate and a heat generating element provided on said substrate; a supporting member supporting said heater, said supporting member being provided with a recess for receiving said heater; a high heat conduction member having a thermal conductivity at least in a direction parallel with a surface higher than a thermal conductivity of said substrate, said high heat conduction member being sandwiched between said heater and said supporting member; wherein a recording material carrying an image is heated by heat from said heater, and wherein a side surface of said heater and a surface, defining said recess and opposing said side surface of said heater, of said supporting member are bonded by adhesive material with each other to fix said heater and said supporting member to each other.

According to another aspect of the present invention, there is provided an image forming apparatus comprising such an image heating apparatus.

Further features of the present invention will become apparent from the following description of exemplary embodiments with reference to the attached drawings.

### BRIEF DESCRIPTION OF THE DRAWINGS

FIGS. 1A and 1B illustrate relationships (No. 1) between a heater, a high heat conduction member, a heater supporting member and a bonding point.

FIGS. 2A and 2B illustrate relationships (No. 2) between a heater, a high heat conduction member, a heater supporting member and a bonding point.

FIG. 3 illustrates an image forming apparatus.

FIG. 4 illustrates an image heating apparatus according to Embodiment 1 of the present invention.

FIG. 5 is a control circuit diagram for a heater.

FIGS. 6A, 6B and 6C illustrate a device according to Embodiment 2.

FIGS. 7A and 7B illustrate a device according to Embodiment 3.

FIG. 8 illustrates a device according to Embodiment 4.

FIGS. 9A and 9B illustrate a device according to Embodiment 5.

FIG. 10 illustrates a modification of Embodiment 4.

FIGS. 11A and 11B illustrate a device according to Embodiment 6.

### DESCRIPTION OF THE EMBODIMENTS

### Embodiment 1

### (1) Image Forming Station:

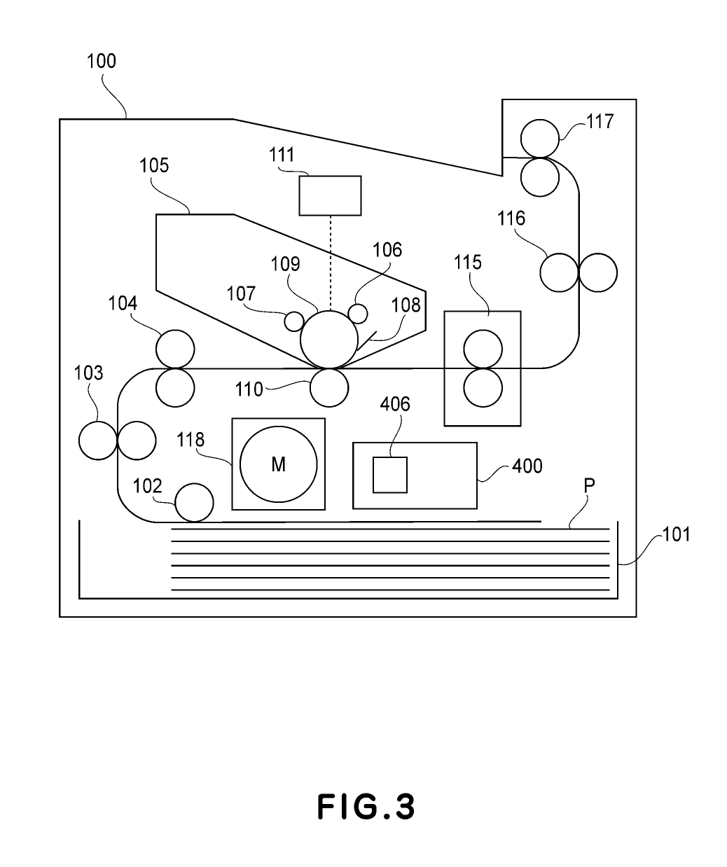

FIG. 3 is a schematic view showing a schematic structure of the image forming apparatus 100. A recording material (recording paper or sheet) P stacked in the sheet feeding cassette 101 is fed out to a process cartridge 105 at predetermined timing by a pick-up roller 102, sheet feeding rollers 103 and registration rollers 104.

The process cartridge 105 comprises charging means 106, developing means 107, cleaning means 108 and a photosensitive drum 109. A known electrophotographic process operation is carried out with the laser beam emitted from image exposure means 111, so that an unfixed toner image is formed on the photosensitive drum 109.

The unfixed toner image is transferred from the photosensitive drum 109 onto the recording paper by the transferring means 110, the recording paper P is introduced into a fixing portion (image heating apparatus) 115, wherein it is subjected to heat pressing process, so that the toner image is fixed on the recording paper P. Thereafter, the recording paper is discharged to the outside of the main assembly of the image forming apparatus 100 through the middle sheet discharging roller 116 and the sheet discharging roller 117, and finishes the series of printing operation. A motor applies a driving force to each unit including the image heating apparatus 115. The image heating apparatus 115 is controlled by a ceramic heater driving circuit 400 and a CPU 406.

The image forming apparatus 100 of this embodiment can be operated with a plurality of sheet sizes. That is, the printing can be effected on a plurality of sheet sizes such as Letter size sheets (approx. 216 mm×279 mm), A4 sheets (210 mm×297 mm), A5 sheets (148 mm×210 mm), set in the sheet feeding cassette 101. Among the sheets usable with the apparatus (under the catalog specifications) a largest width sheet is the Letter size sheet (approx. 216 mm width). In the description of the embodiments, a sheet (A4, A5 sheets) having a width smaller than the largest width is called small size sheet.

### (2) Fixing Device (Image Heating Apparatus)

### (2-1) General Structure of the Apparatus:

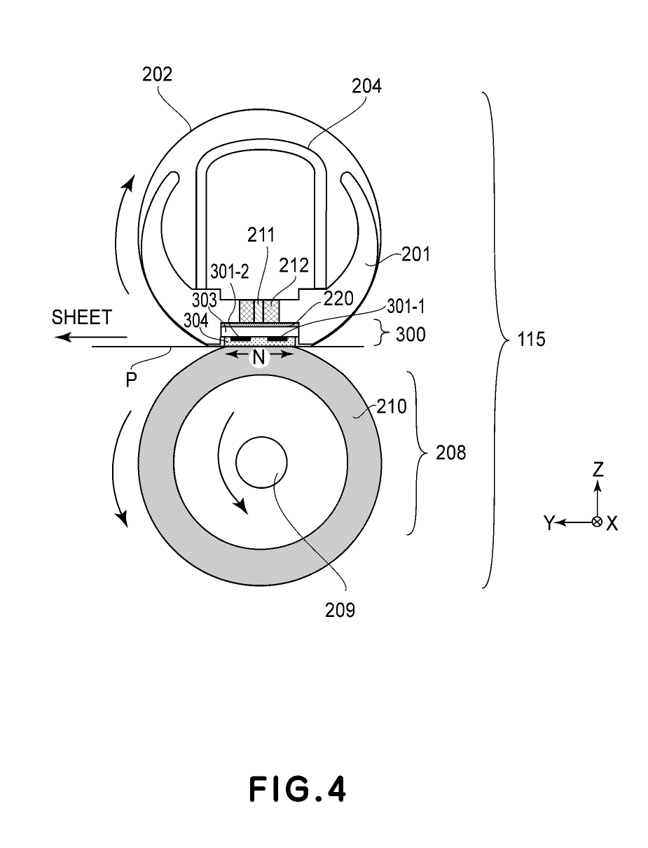

FIG. 4 is a lateral schematic sectional view of major parts of the fixing device 115 of the image forming apparatus 100. The fixing device 115 comprises a cylindrical film (movable member) 202, a heater (heating element) 300 contacted with an inner surface of a film 202, and a pressing roller (nip forming member) 208 cooperative with the heater 300 to form a fixing nip N with the film 202 therebetween. The film 202 includes a base layer of heat resistive resin material such as polyimide or a metal such as stainless steel. The pressing roller 208 includes a core metal 209 of steel, aluminum or the like, and an elastic layer 210 of silicone rubber or the like.

The heater 300 is supported on a heater supporting member (heating element supporting member) 201 of heat resistive resin material. The heater supporting member 201 functions also as a guiding function for guiding rotation of the film 202. The pressing roller 208 receive a power from a motor 118 two rotated in the direction indicated by an arrow. By the rotation of the pressing roller 208, the film 202 is rotated. Designated by 204 is a stay of metal for applying a pressure to the heater supporting member 201 using a spring (unshown).

The heater 300 is a ceramic heater elongated in the direction perpendicular to the sheet feeding direction in a recording paper feeding path plane, and it includes a heater substrate 303 of ceramic material. It further includes a heat generating resistor (heat generating element) 301-1 provided extending on the heater substrate 303 along with the length of the substrate, and a heat generating resistor 301-2 extending along the longitudinal direction of the substrate at the position different from that of the heat generating resistor 301-1 in the widthwise direction of the substrate. It further includes an insulative surface protection layer 304 (glass material on this embodiment) coating the heat generating resistors 301-1 and 301-2.

The surface protection layer 304 of the heater 300 is at the sheet passing side (front side of the heater), and the inner surface of the film 202 slides on the protection layer 304 in the nip N portion.

Between the heater supporting member 201 and the heater 300, a high heat conduction member 220 is provided. The high heat conduction member 220 is a member of the material which has a thermal conductivity higher than the thermal conductivity of the heater substrate 303 at least in a direction parallel with the surface thereof. An example of the high heat conduction member is a graphite sheet. Another example of the high heat conduction member 220 is a thin metal plate of aluminum or the like.

To the high heat conduction member 220, a thermister (temperature detecting element) 211 is contacted. In addition, to the high heat conduction member 220, a protection element 212 such as a thermo-switch and/or a temperature fuse or the like is contacted to operate to shut off the electric energy supply line to the heat generating region when the temperature of the heater 300 anomaly rises.

The thermister 211 and the protection element 212 are pressed against the high heat conduction member 220 by a leaf spring (unshown) or the like. The recording paper P carrying the unfixed toner image is heated by the fixing nip N while being nipped and fed in the fixing nip N, so that the toner image is fixed.

### (2-2) Heater Temperature Control:

A heater temperature control will be described. As for the types of the heater temperature control, there are a wave number control, a phase control, and a so-called hybrid control include the wave number control and the phase control in combination. In the phase control, ON-ratio (duty ratio) in one half wave period of the commercial AC waveform, and is suitable to suppress flickering. On the other hand, in the wave number control, ON or OFF of the heat generating element of the heater 300 is switched in unit of half wave unit of the commercial AC waveform (ON ratio (duty ratio) is switched in a period corresponding to a predetermined number of half waves), and is suitable to suppress harmonic current distortion or switching noise.

In the hybrid control, a part of the half waves in one control cyclic period including a plurality of half waves is phase-controlled, and the rest is wave-number-controlled, by which the production of the harmonic current and/or the switching noise can be suppressed as compared with the case of the phase control alone. Furthermore, as compared with the case of the wave number control alone, the flickering can be reduced. Generally, the image forming apparatus uses only one of the three types of controls, depending on the voltage and/or production of the flickering of the available commercial AC voltage source.

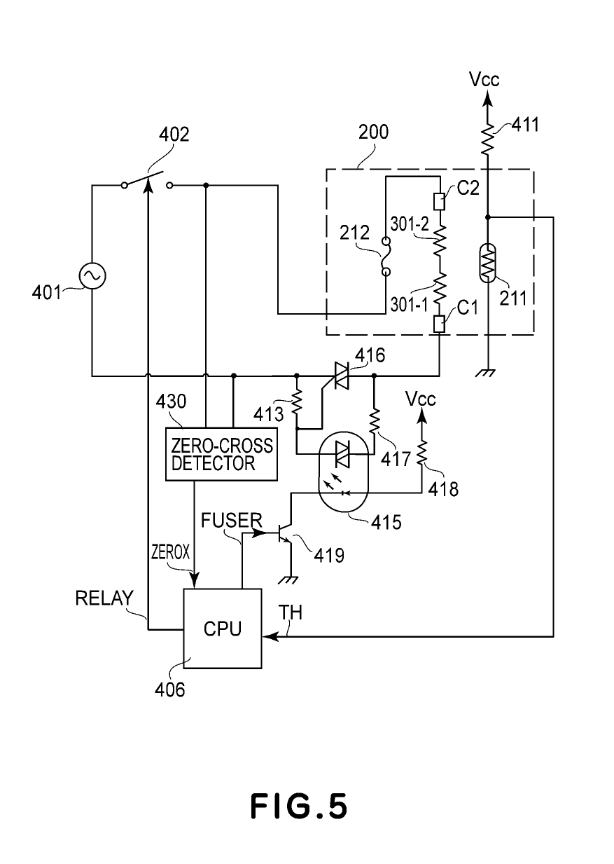

FIG. 5 illustrates an electric power control portion 400 of the heater 300 in this embodiment. Designated by reference numeral 401, is a commercial AC voltage source to which the image forming apparatus 100 is connected. The electric power control of the heater 300 is carried out by ON and OFF of a TRIAC 416. The electric power supply to the heater 300 is carried out through contact portions C1 and C2, and the electric power is supplied to the heat generating resistors 301-1 and 301-2 of the heater 300.

A zero-cross detection portion 430 is a circuit for detecting a zero-cross of the waveform of the AC voltage source 401 and supplies a ZEROX signal to the CPU 406. The ZEROX signal is used for the control of the heater 300, and the zero-cross circuit may be the circuit disclosed in Japanese Laid-open Patent Application 2011-18027, for example.

The operation of the TRIAC 416 will be described. Resistances 413 and 417 are current limiting resistors for the TRIAC 416, and a photo-TRIAC coupler 415 is a device for assuring a creeping distance between the primary and secondary sides. When a light emitting diode of the photo-TRIAC coupler 415 is turned on, the TRIAC 416 is turned on. The resistance 418 limits the current through the light emitting diode of the photo-TRIAC coupler 415. The photo-TRIAC coupler 415 is rendered on and off by a transistor 419. The transistor 419 is operated in accordance with a FUSER signal supplied from the CPU 406.

The thermister 211 has a resistance value which changes in accordance with the temperature. To the CPU 406, a TH signal which corresponds to a voltage provided by dividing the voltage Vcc by the resistance value of the thermister 211 and the resistance value of the resistance 411 is supplied. That is, the signal TH response to the detected temperature by the thermister 211. In the inside process of the CPU 406, the electric power to be supplied is calculated by PI control on the basis of the detected temperature of the thermister 211 and a set temperature for the heater 300. In addition, the CPU 406 calculates a control level (a phase angle in the case of the phase control, and a wave number in the case of the wave number control) correspondingly to the electric power to be supplied, and controls the TRIAC 416.

If the state of the fixing device 115 becomes abnormal state exceeding the normal heating state by a malfunction of the electric power control portion such as short circuit in the TRIAC 416, for example, the protection element 212 operates to shut off the electric power supply to the heater 300. Also, when the thermister detected temperature (TH signal) exceeds a predetermined temperature, a relay 402 is opened to shut off the electric power supply to the heater 300.

### (2-3) Bonding of the Heater to the Heater:

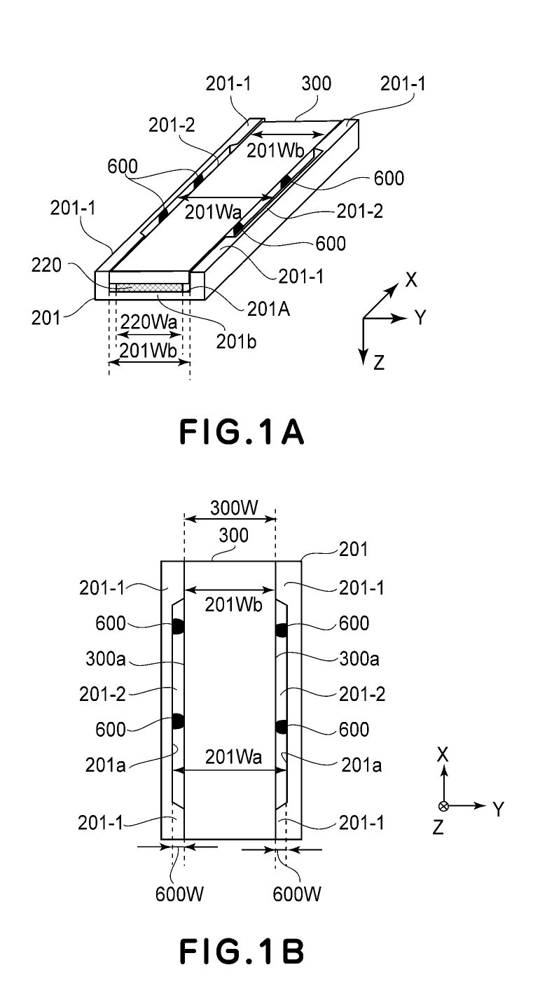

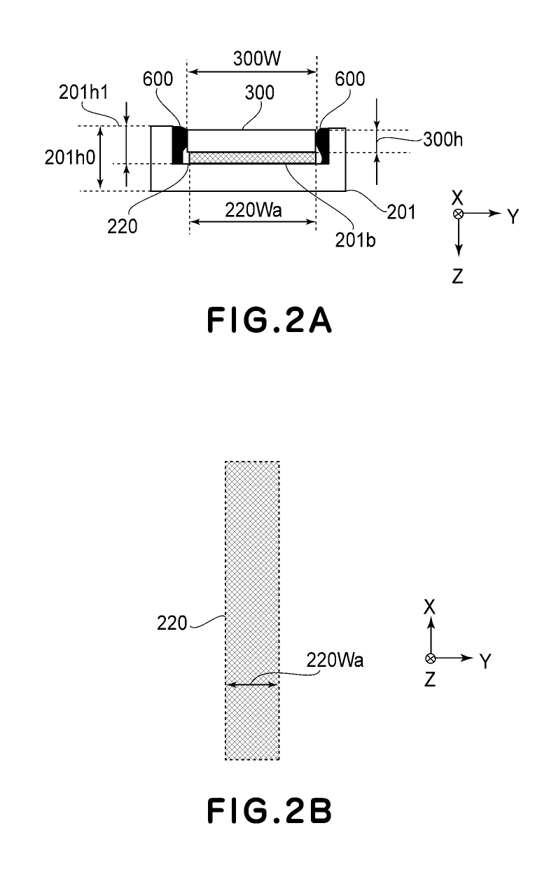

FIGS. 1A, 1B, 2A and 2B illustrate a bonding point between the heater 300 and the heater supporting member 201 in this embodiment. In these Figures, only major parts of the supporting member 201 of FIG. 4 are shown, and the other parts such as the film guide portion are omitted.

The supporting member 201 is provided with a groove portion (recess) 201A for receiving the heater 300, and the heater 300 said in the groove portion 201A is fixed to the heater supporting member 201 by an adhesive material 600. More specifically, a side surface 300a of the heater and the surface of the supporting member 201 opposing to the side surface 300a of the heater (the surface defining the groove portion 201A) 201a are bonded by the adhesive material 600, so that the heater 300 is fixed to the supporting member 201. The configuration or the like of the supporting member 201 will be described in detail.

The supporting member 201 is provided with the groove portion 201A extending in the longitudinal direction of the supporting member (X axis direction in the Figure) and having a channel-like cross-section. The heater 300 is fitted in the groove portion 201A with the sheet passing side side (surface side of the heater) outside. The high heat conduction member 220 is sandwiched between the seat the bottom surface of the groove portion) 201b and the heater 300. The heater 300 and the heater supporting member 201 are bonded by the adhesive material 600 applied in a space 201-2 between the side surface 300a of the heater 300 and an internal wall surface (second surface) 201a of the heater supporting member 201. The number of the bonding positions between the side surface 300a and the internal wall surface 201a may be at least one. The heater is fixed to the supporting member by the adhesive material. In this embodiment, the used adhesive material is heat resistive silicone rubber adhesive material. More specifically, it is silicone rubber KE-3417 (tradename) available from Shinnetsu silicone Kabushiki Kaisha, Japan.

The opposite end portions of the supporting member with respect to the longitudinal direction (X axis direction) of the supporting member are provided with two projections (heater supporting portions), respectively. A gap between two projections 201-1 opposed to each other in a Y axis direction (clearance between opposing surfaces (first surfaces) of the projections) 201Wb is equivalent to or a little bit wider than a width 300W of the heater 300. Therefore, the position of the heater 300 fitted in the groove portion 201A is limited in the position with respect to the Y axis direction, by the projections 201-1. In this mariner, the supporting member has a first surface opposing a side surface of the heater, and a second surface opposing the side surface of the heater, the second surface being remoter from the side surface of the heater than the first surface, and the adhesive material is applied into between the side surface of the heater and the second surface of the supporting member.

A dimensional relation between the gap (width) 201Wa between the two surfaces 201a opposing in the Y axis direction and the width 300W of the heater 300 is,

201Wa>300W.

In addition, 201Wa>201Wb, and

201Wb≧300W are satisfied.

In the example of FIGS. 1A and 1B, the heater 300 and the heater supporting member 201 are bonded by the adhesive material 600 at four positions. As shown FIGS. 1A and 1B, two spaces 201-2 are provided where the adhesive material is applied, and the adhesive material is applied at two positions for each of the spaces. The position of the adhesive material application in one of the spaces 201-2 and that of the other space 201-2 are substantially the same with respect to the X axis direction (longitudinal direction of the heater).

A distance 600W between the side surface 300a of the heater and the surface 201a of the supporting member is,

600W=(201Wa−300W)/2.

The width 600W is substantially constant along the X axis direction over the area of surface 201a.

As shown in FIG. 2A, a width 220Wa of the high heat conduction member and the width 300W of the heater 300 satisfy 220Wa≦300W. The side surface 300a of the heater 300 has a thickness 300h, and the internal wall surface 201a of the heater supporting member 201 has a height 201h1. The adhesive material 600 is applied in the region of the thickness 300h and the region of the thickness 201h1 so as not to contact the high heat conduction member 220. By this, the adhesive material 600 does not easily enter between the heater 300 and the high heat conduction member 220, so that the close contact state is maintained. The high heat conduction member 220 is not provided with a cut-away portion for the bonding as shown in FIG. 2B. Therefore, the thermo-conductive performance (uniform heating function) with respect to the direction parallel with the surface of the high heat conduction member 220 can be provided efficiently.

By the provision of the spaces 201-2 for the application of the adhesive material as in this example, it is easy to inject the adhesive material 600 after the high heat conduction member 220 and the heater 300 are inserted into the groove of the supporting member 201, and therefore, the assembling property of the device is improved.

The dimensional relation between the width 201Wb of the seat 201b of the groove portion 201A (FIG. 1A) and the width 220Wa of the high heat conduction member 220 is,

201Wb≧220Wa.

In addition, the relationships between the thickness 201h0 of the heater supporting member 201, the height 201h1 of the wall surface 201a, related with the bonding, of the heater supporting member 201, and the thickness 300h of the heater 300 are,

201h0>201h1>300h.

### Embodiment 2

In this Embodiment 2, an internal wall surface 201a of the heater supporting member 201 is provided with recessed portions 201-3 to clearly define the positioning of the adhesive material 600. The recessed portions 201-3 have a function of confining the adhesive material 600, by which the positional accuracy of the adhesive material application is improved, and the bonding operation is made easy. In the description of this embodiment, the same reference numerals as in Embodiment 1 are assigned to the elements having the corresponding functions in this embodiment, and the detailed description thereof is omitted for simplicity.

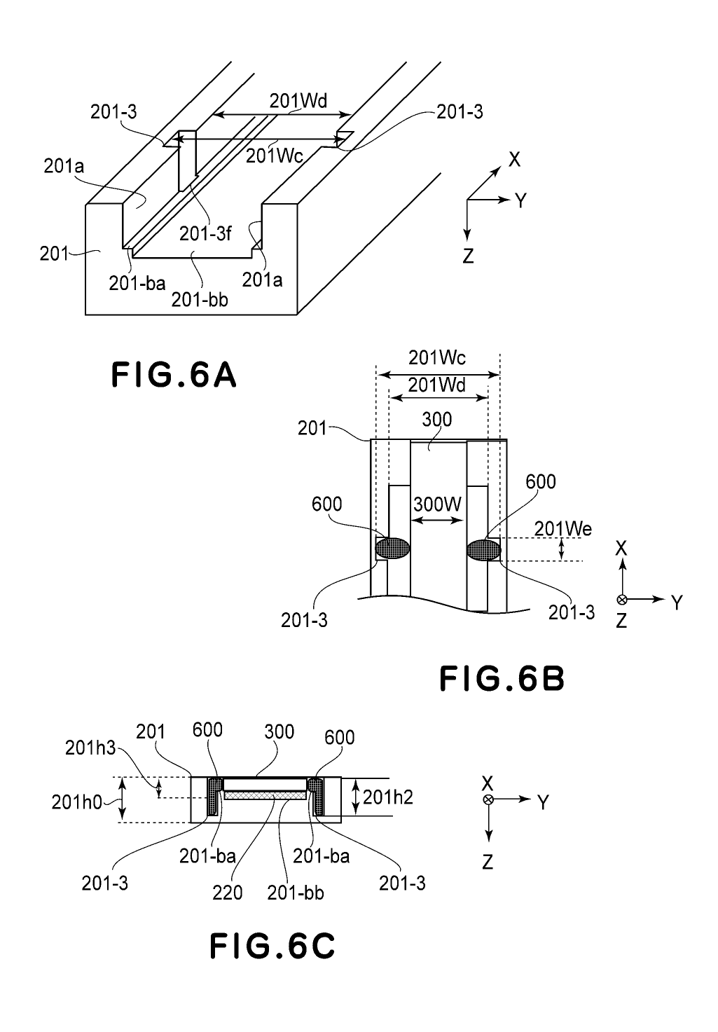

FIG. 6A shows a schematic structure of this Embodiment 2. In this z o embodiment, the internal wall surface 201a of the heater supporting member 201 is provided at the bonding positions with recessed portions 201-3 in the widthwise direction of the supporting member. The relationships between the width 300W of the heater 300, the width 201Wd of the groove portion 201A of the heater supporting member 201 (the gap between the opposing surfaces 201a), and a width 201We of the recess 201-3 is 201Wc>201Wd>300W.

FIG. 6B shows positional relations below the heater 300, the heater supporting member 201 and the adhesive material 600, and FIG. 6C is a sectional view. The recessed portions 201-3 is provided so that they are opposed to the internal wall surface 201a of the supporting member 201. The heater supporting member 201 with heater 300 are fixed to each other at the positions of the recessed portions 201-3.

The adhesive material 600 is applied in regions of the recessed portions defined by the width 201We and the deep 201h2. Designated by 201h0 is a thickness of the heater supporting member 201. Designated by 201h3 is a sum of the thickness of the heater 300 or the thickness of the heater supporting member 201 and the thickness of the high heat conduction member 220. The relationships therebetween are,

201h0>201h2≧201h3.

With such a structure, the bonding positions are clearly defined, and an excess adhesive material 600 flows into depth of the recessed portions until the adhesive material is cured after the application thereof. By this, protrusion of the adhesive material to the contact portion between the heater 300 and the film 202 can be suppressed.

In addition, a depth of the seat 201-bb on which the high heat conduction member 220 is mounted is deeper than the surface 201-ba having an entrance edge 201-3f of the recessed portion 201-3. By this, the adhesive material is not easily deposited on the high heat conduction member 220, and the problem of deformation of the high heat conduction member attributable to the shrinkage of the adhesive material.

### Embodiment 3

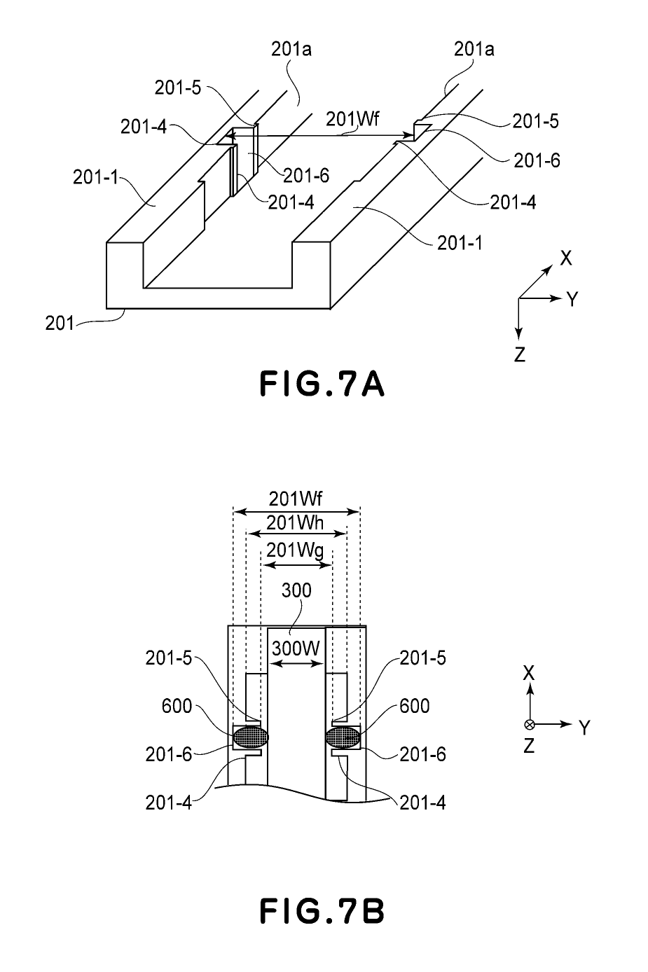

FIGS. 7A and 7B are illustrations of this Embodiment 3. In the description of this embodiment, the same reference numerals as in Embodiments 1 and 2 are assigned to the elements having the corresponding functions in this embodiment, and the detailed description thereof is omitted for simplicity. FIG. 7A shows a schematic structure, and part (b) shows positional relationships of the bonding positions between the heater 300, the heater supporting member 201 and the adhesive material bonding positions. In this Embodiment 3, adhesive material movement prevention walls 201-4, 201-5 are provided at the bonding positions of the internal wall surface 201a of the heater supporting member to prevent the movement of the adhesive material 600 in the longitudinal direction of the heater 300.

The relationships between a width 201Wg between the free end portions of the prevention walls 201-4 (201-5) opposing to each other in the Y axis direction, a width 201Wh between the opposing internal wall surfaces 201a, a width 201Wf between the opposing recessed portions 201-6 and a width 300W of the heater 300 are,

201Wf≦201Wh>201Wg>300W.

By the provision of such movement prevention walls 201-4, 201-5, the protrusion of the adhesive material 600 in the longitudinal direction of the heater 300 can be prevented.

### Embodiment 4

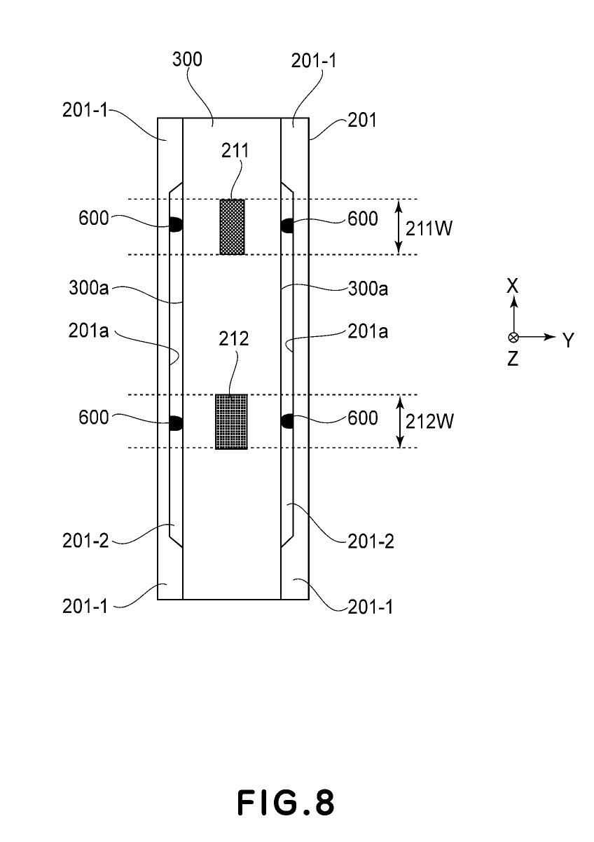

FIG. 8 is an illustration of the device according to Embodiment 4. In this Embodiment 4, the positions of the heater supporting member 201 wherein the adhesive material is applied is in the ranges of widths 211W, 212W of the protection element 212 and the temperature detecting element 211, respectively. That is, the bonding positions are adjacent to the positions where the elements 211, 212 are provided, with respect to the X axis direction. In the description of this embodiment, the same reference numerals as in Embodiments 1, 2 and 3 are assigned to the elements having the corresponding functions in this embodiment, and the detailed description thereof is omitted for simplicity.

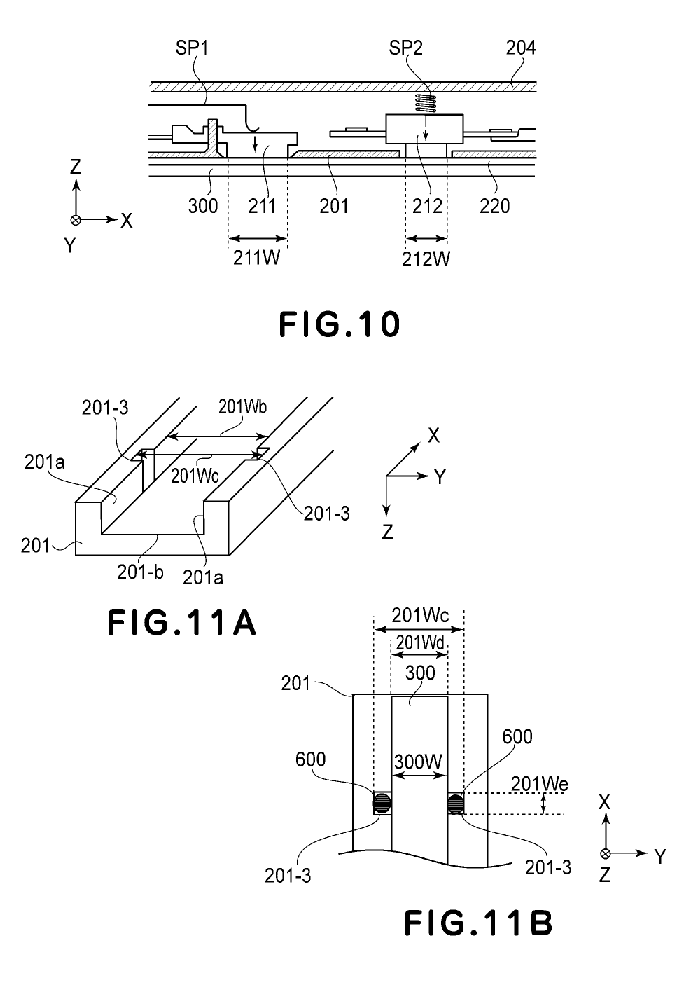

As shown in FIG. 10, the protection element 212 and the temperature detecting element 211 are pressed by springs SP1 and SP2 in the direction of urging the heater 300 away from the seat of the supporting member 201. Therefore, the stress of the heater in these positions is relatively large as compared with the other portions.

The adhesive material 600 is applied in the position of at least one of the width 212W range where the protection element 212 and the high heat conduction member 220 contact to each other and the width 211W range where the temperature detecting element 211 and the high heat conduction member 220 contact to each other. By this, the stress of the heater 300 can be eased, and the close contact between the high heat conduction member 220 and the heater 300 is improved. This feature of Embodiment 4 may be used in any one of Embodiments 1, 2 and 3.

With such a structure, it is unnecessary to provide a cut-away portion for the application of the bonding material 600, in the high heat conduction member 220, and the high heat conduction member 220 can be used efficiently without influence of the structure of the image heating apparatus.

### Embodiment 5

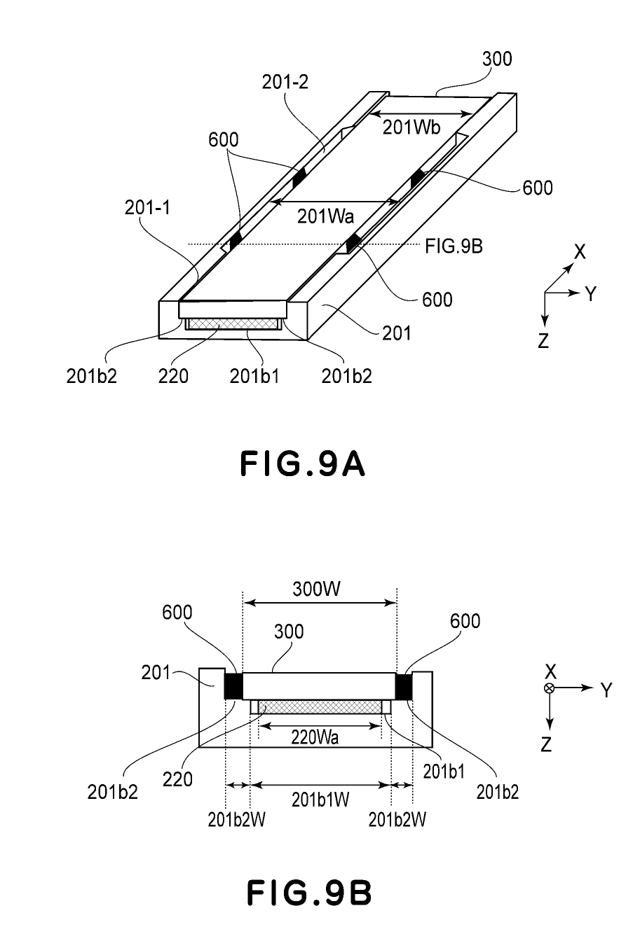

FIGS. 9A and 9B illustrate Embodiment 5. In this embodiment, the seat 201b2 (width is 201b2W) of the supporting member supporting the heater 300 and the seat 201b1 (width is 201b1W) of the supporting member supporting the high heat conduction member 220 are not flush with each other. Such a structure is also effective to prevent the position of the adhesive material 600 to the high heat conduction member 220.

### Embodiment 6

FIGS. 11A and 11B illustrates Embodiment 6. In the apparatus of this embodiment, no such spaces 201-2 as with the supporting member of Embodiment 1 are provided, and the side surface of the heater 300 is supported by the supporting member over the area along the X direction, except for the recessed portion 201-3. In FIG. 11B, a high heat conduction member is provided in a downstream side of the heater 300 with respect to a Z axis direction, but it is omitted in this Figure.

### [Others]

(1) the heating element 300 is not limited to the ceramic heater used in the foregoing embodiments. A heater using Nichrome wire, an induction heat generation member capable of electromagnetic induction heat generation using an excitation coil are usable in place thereof.

(2) the use of the image heating apparatus according to the present invention is not limited to the above-described fixing device. It is usable with an image improving device for improving glossiness or the like by reheating the once or temporarily fixed toner image on the recording material.

(3) the image forming station of the image forming apparatus is not 2o limited to the image forming station of the electrophotographic type. It may be an electrostatic recording type or a magnetic recording type. The image forming apparatus is not limited to that of the transfer type, but is usable with a direct transfer type in which the toner image is directly transferred onto the recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2014-104284 filed on May 20, 2014 and 2015-062476 filed on Mar. 25, 2015, which are hereby incorporated by reference herein in their entirety.

What is claimed is:

1. An image heating apparatus comprising:
a heater including a substrate and a heat generating element provided on said substrate;
a supporting member supporting said heater, said supporting member being provided with a recess for receiving said heater;
a high heat conduction member having a thermal conductivity at least in a direction parallel with a surface higher than a thermal conductivity of said substrate, said high heat conduction member being sandwiched between said heater and said supporting member;
wherein a recording material carrying an image is heated by heat from said heater, and
wherein a side surface of said heater and a surface, defining said recess and opposing said side surface of said heater, of said supporting member are bonded by adhesive material with each other to fix said heater and said supporting member to each other.

2. An apparatus according to claim 1, wherein said supporting member has a first surface opposing to said side surface of said heater, and a second surface opposing said side surface of said heater and remoter than said first surface from said side surface of said heater, and wherein said adhesive material is applied between said side surface of said heater and said second surface.

3. An apparatus according to claim 1, wherein the adhesive material is applied in a first space between said supporting member and one of side surfaces of said heater and in a second space between said supporting member and the other side surface of said heater, wherein positions of the adhesive materials applied in the first space and in the second space are the same with respect to a longitudinal direction of said heater.

4. An apparatus according to claim 1, wherein said adhesive material is out of contact with said high heat conduction member.

5. An apparatus according to claim 1, wherein the second surface is provided with a recessed portion recessed away from the side surface of said heater, and the adhesive material is applied in said recessed portion.

6. An apparatus according to claim 5, wherein said recessed portion is provided with a portion which is deeper than a seat of said supporting member which supports said heater.

7. An apparatus according to claim 1, further comprising a temperature detecting element for detecting a temperature of said heater, wherein said adhesive material is applied to a position which is the same as a position of said temperature detecting element with respect to a longitudinal direction of said heater.

8. An apparatus according to claim 1, further comprising a protection element for shutting off electric power supply to said heater, wherein said adhesive material is applied to a position which is the same as a position of said protection element with respect to a longitudinal direction of said heater.

9. An apparatus according to claim 1, wherein a depth of a seat of said supporting member which supports the heater and a depth of a seat of said supporting member which supports said high heat conduction member are different from each other.

10. An apparatus according to claim 1, further comprising a cylindrical film rotatable while contacting said heater at an inner surface of said cylindrical film, wherein an image on a recording material is heated by said heater through said film.
